(19) United States
(12) Patent Application Publication
(10) Pub. No.: US 2014/0280220 A1
(43) Pub. Date: Sep. 18, 2014

(54) SCORED STORAGE DETERMINATION

(71) Applicant: SAS Institute Inc., Cary, NC (US)

(72) Inventors: Gary Spakes, Apex, NC (US); Scott Meredith Chastain, Fuquay-Varina, NC (US); Bryan Christopher Harris, Marriottsville, MD (US)

(73) Assignee: SAS Institute Inc., Cary, NC (US)

(21) Appl. No.: 14/206,183

(22) Filed: Mar. 12, 2014

Related U.S. Application Data
(60) Provisional application No. 61/779,971, filed on Mar. 13, 2013.

(51) Int. Cl. G06F 17/30

(52) U.S. Cl. CPC G06F 17/30312
USPC 707/748

(57) ABSTRACT

A method of determining a storage device on which to store received data is provided. Data is received. A score indicating a value associated with the received data is computed. A storage device is determined from a plurality of types of storage devices on which to store the received data based on the computed score. The received data is sent to the determined storage device.

### CROSS-REFERENCE TO RELATED APPLICATIONS

The present application claims priority under 35 U.S.C. §119(e) to U.S. Provisional Patent Application No. 61/779,971 filed on Mar. 13, 2013, the entire contents of which are hereby incorporated by reference.

### BACKGROUND

Traditional data management strategies do not scale to effectively govern large data for high-performance analytics. Enterprise data is often held in disparate applications across departments and geographies leading to poor service, redundancies, inaccuracies and, ultimately, a higher cost of doing business.

### SUMMARY

In an example embodiment, a method of determining a storage device on which to store received data is provided. Data is received. A score indicating a value associated with the received data is computed. A storage device is determined from a plurality of types of storage devices on which to store the received data based on the computed score. The received data is sent to the determined storage device.

In another example embodiment, a computer-readable medium is provided having stored thereon computer-readable instructions that, when executed by a computing device, cause the computing device to perform the method of determining a storage device on which to store received data.

In yet another example embodiment, a computing device is provided. The system includes, but is not limited to, a processor and a computer-readable medium operably coupled to the processor. The computer-readable medium has instructions stored thereon that, when executed by the computing device, cause the computing device to perform the method of determining a storage device on which to store received data.

In still another example embodiment, a system is provided. The system includes, but is not limited to, a computing device and a plurality of storage devices. The computing device includes, but is not limited to, a processor and a computer-readable medium. The computer-readable medium is operably coupled to the processor and has computer-readable instructions stored thereon that, when executed by the processor, cause the computing device to perform the method of determining a storage device on which to store received data.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a storage routing device in accordance with an illustrative embodiment.

FIG. 2 depicts a flow diagram illustrating examples of operations performed by the storage routing device of FIG. 1 in accordance with an illustrative embodiment.

FIG. 3 depicts a block diagram of a data storage determination system in accordance with an illustrative embodiment.

FIG. 4 depicts a second flow diagram illustrating second examples of operations performed by the storage routing device of FIG. 1 in accordance with an illustrative embodiment.

FIG. 5 depicts graphs presenting storage information associated with use of the data storage determination system in accordance with an illustrative embodiment.

### DETAILED DESCRIPTION

Referring to FIG. 1, a block diagram of a storage routing device 100 is shown in accordance with an illustrative embodiment. Storage routing device 100 may include an input interface 102, an output interface 104, a communication interface 106, a computer-readable medium 108, a processor 110, and a storage routing application 112. Fewer, different, and/or additional components may be incorporated into storage routing device 100.

Input interface 102 provides an interface for receiving information from the user for entry into storage routing device 100 as understood by those skilled in the art. Input interface 102 may interface with various input technologies including, but not limited to, a keyboard 114, a mouse 116, a display 118, a track ball, a keypad, a microphone, one or more buttons, etc. to allow the user to enter information into storage routing device 100 or to make selections presented in a user interface displayed on the display. The same interface may support both input interface 102 and output interface 104. For example, a display comprising a touch screen both allows user input and presents output to the user. Storage routing device 100 may have one or more input interfaces that use the same or a different input interface technology. The input interface technology further may be accessible by storage routing device 100 through communication interface 106.

Output interface 104 provides an interface for outputting information for review by a user of storage routing device 100. For example, output interface 104 may interface with various output technologies including, but not limited to, display 118, a speaker 120, a printer 122, etc. Storage routing device 100 may have one or more output interfaces that use the same or a different output interface technology. The output interface technology further may be accessible by storage routing device 100 through communication interface 106.

Communication interface 106 provides an interface for receiving and transmitting data between devices using various protocols, transmission technologies, and media as understood by those skilled in the art. Communication interface 106 may support communication using various transmission media that may be wired and/or wireless. Storage routing device 100 may have one or more communication interfaces that use the same or a different communication interface technology. For example, storage routing device 100 may support communication using an Ethernet port, a Bluetooth antenna, a telephone jack, a USB port, etc. Data and messages may be transferred between storage routing device 100 and a plurality of storage devices 130, data source systems 132, and/or reporting device 134 using communication interface 106.

Computer-readable medium 108 is an electronic holding place or storage for information so the information can be accessed by processor 110 as understood by those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Storage routing device 100 may have one or more computer-readable media that use the same or a different memory media technology. Storage routing device 100 also may have one or more drives that support the loading of a memory media such as a CD, DVD, an external hard drive, etc. One or more external hard drives further may be connected to storage routing device 100 using communication interface 106.

Processor 110 executes instructions as understood by those skilled in the art. The instructions may be carried out by a special purpose computer, logic circuits, or hardware circuits. Processor 110 may be implemented in hardware and/or firmware. Processor 110 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 110 operably couples with input interface 102, with output interface 104, with communication interface 106, and with computer-readable medium 108 to receive, to send, and to process information. Processor 110 may retrieve a set of instructions from a permanent memory device and copy the instructions in an executable form to a temporary memory device that is generally some form of RAM. Storage routing device 100 may include a plurality of processors that use the same or a different processing technology.

Storage routing application 112 performs operations associated with determining a storage device of the plurality of storage devices 130 on which to store received data. Some or all of the operations described herein may be embodied in storage routing application 112. The operations may be implemented using hardware, firmware, software, or any combination of these methods. Referring to the example embodiment of FIG. 1, storage routing application 112 is implemented in software (comprised of computer-readable and/or computer-executable instructions) stored in computer-readable medium 108 and accessible by processor 110 for execution of the instructions that embody the operations of storage routing application 112. Storage routing application 112 may be written using one or more programming languages, assembly languages, scripting languages, etc.

Storage routing application 112 may be implemented as a Web application. For example, storage routing application 112 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Referring to FIG. 2, example operations associated with storage routing application 112 are described. Additional, fewer, or different operations may be performed depending on the embodiment. The order of presentation of the operations of FIG. 2 is not intended to be limiting. Although some of the operational flows are presented in sequence, the various operations may be performed in various repetitions, concurrently (in parallel, for example, using threads), and/or in other orders than those that are illustrated.

In an operation 200, data is received. Data may be received in a data stream or via messaging. The data may be received from data source systems 132. Data source systems 132 may include one or more data sources. The data received may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art.

The incoming data received can be of various types. For example, in some cases, the incoming data can be financial data, stock data, cash register data, ATM data, and the like. Some data may be data that is suited for batch storage, such as data that is stored in a storage device once or twice a day. Some types of data may be real-time data, and still other types of data may be micro-batch data, where the batch data may be for a shorter amount of time than the batch data. For example, the micro-batch data may be data collected for 30 seconds or two minutes of data (e.g., data from transactions from a cash register), whereas the batch data may be for data collected for 6, 12 or 24 hours, for instance.

In an operation 202, a score for the received data is computed. The computed score indicates a worth or a value associated with the received data and the importance or relevance of the data to an entity receiving the data. For example, social media information about competitors may be received for analysis. To improve storage and cost efficiencies for what is potentially a vast amount of data, the entity's competitors may be evaluated based on market share and competitive sales. Competitor social media data may be received, for example, through streaming. Each event may be scored based on the results of the competitor evaluation. The computed score for message events deemed highly relevant may have a high score; whereas, the computed score for message events deemed less relevant may have a lower score. Of course, a high score may be associated with less relevant messages and a low score may be associated with more relevant messages in an alternative embodiment.

As another example, a competitor may announce a new product launch using Twitter. Because this information may be identified as very important to the entity receiving the data, the computed score for message events associated with the new product launch may have a high score.

As yet another example, a competitor tweets about a presentation at a conference. Because this information may be identified as relatively unimportant to the entity receiving the data, the computed score for message events associated with the presentation at a conference may have a low score.

As yet another example, data is received from an automatic teller machine (ATM). A score or weight could be calculated based on a type of transaction such as an authorization/authentication transaction, an informational transaction such as a balance check, a withdrawal transaction, a deposit transaction, and a transfer transaction. Other factors could be considered in determining the score such as a time interval between interactions with the ATM. For example, an authorization may receive a low score, unless multiple authorizations within a specified time interval occur in which case, the authorization may receive a high score. A withdrawal transaction may receive a low score except when combined with a balance check, and a withdrawal that reduces the amount of available money below a specified threshold. In this situation, the withdrawal transaction may receive a high score.

The “score” or “weight” is an analytic based on varying factors that are specific to the entity receiving the data. In a retail sector, the factors may be market based. In a healthcare sector, the factors may be hospital admission and diagnosis based. In a telecommunications sector, the factors may be type of phone, a length of plan, a usage pattern, etc. A real-time example may evaluate a competitor's social media feed, analyze and score the text, and route IPO or partnering information directly to an executive's smartphone while routing product information to a different location for later analysis.

The storage routing application may execute or run a scoring algorithm to compute the score as understood by a person of skill in the art. Optionally, the received data may be transformed before computing the score. Various software tools may be used to develop and execute the scoring algorithm including the SAS® In-Memory Analytics software tool, the SAS® High-Performance Analytics Server software tool, the SAS® Scoring Accelerator software tool, the SAS® Enterprise Miner™ software tool, SAS/STAT® software tool, the SAS® Event Stream Processing Engine software tool, etc.

In an operation 204, a storage device of a plurality of types of storage devices on which to store the received data is determined. A data storage device is a computer-readable medium for recording (storing) information (data). The storage device may hold information, process information, or both. Referring to FIG. 1, the plurality of storage devices 130 may include any number of data storage devices such as a first storage device 130a, a second storage device 130b, a third storage device 130c, . . . , and an nth storage device 130n. Each storage device may include one or more hardware devices that include any type of computer-readable medium. Software may be used to coordinate/control access to the computer-readable medium of each storage device. Each of the plurality of storage devices 130 represents a different type of data storage device.

The data may be stored to the data storage device using various formats as known to those skilled in the art including a file system, a relational database, a system of tables, a structured query language database, block level data storage, etc. The data storage device may include electronic file storage systems of any media type including optical media storage, magnetic media storage, semiconductor media storage, magneto-optical media storage, etc. that provide random and/or sequential data access.

The data storage devices may be parallelized and managed using various combinations of hardware and software systems. For example, first storage device 130a may be implemented as a multi-node Hadoop® cluster, second storage device 130b may be implemented as a grid of computers, third storage device 130c may be implemented as a data warehouse, nth storage device 130n may be implemented as a file system, etc. As another example, another storage device of the plurality of storage devices 130 may be implemented as a SAS® LASR Analytic Server that provides multi-user access to in-memory data in a distributed computing environment. As yet another example, another storage device of the plurality of storage devices 130 may be implemented as a mainframe computer executing server software. As still another example, another storage device of the plurality of storage devices 130 may be implemented as cloud storage.

A relative cost, an ease of access, and/or an access time may be associated with use of each of the plurality of types of storage devices. For example, Table I below shows examples for various types of storage devices.

TABLE I

| Type of | | Relative ease | Relative |
|---|---|---|---|
| storage device | Relative cost | of access | access time |
| Hadoop ® | Low | Easy | Medium |
| Cloud | Low | Medium | Medium |
| Tape | Low | Hard | Slow |
| (magnetic) | | | |
| Disk array | Medium/high | Easy | Medium |
| Relational | High | Easy | Fast |
| database | | | |
| management | | | |
| system | | | |
| Mainframe | High | Medium | Fast |

To determine the storage device to which to store the data based on the computed score, a threshold may be defined for each storage device of the plurality of types of storage devices. For example, a high threshold may be associated with a high cost and/or a fast access time and may be used to store relatively higher value received data. The thresholds associated with each storage device may increase monotonically so that the storage device determined is the storage device for which the computed score is less than or equal to the threshold for the associated storage device. Other uses of the threshold may be used as understood by a person of skill in the art. For example, the thresholds may decrease monotonically, and the storage device determined is the storage device for which the computed score is greater than or equal to the threshold for the associated storage device.

The storage device may be determined by comparing the score to the threshold associated with each of the plurality of types of storage devices. The determination may further be based on a default storage device assignment unless the comparison indicates a different storage device of the plurality of types of storage devices. For example, the received data may be stored in the lowest cost storage device such as first storage device 130a implemented as a multi-node Hadoop® cluster unless the threshold is exceeded for a different type of storage device.

In some embodiments, each of the various types of storage devices may also be assigned a value (e.g., low, medium, high, or a numerical value) based on, at least in part, a maximum storage size of the storage device, a reliability of the storage device, a volatility of the storage device, an age of the storage device, a location of the storage device, a portability of the storage device, an expandability of the storage device, an amount of parallelism of the storage device, a security of the storage device, a data transmission rate of the storage device, a removability of the storage device, an energy use of the storage device (e.g., eco-devices), an operating system of the storage device, an amount of clustering of multiple storage devices, a manufacturer of the storage device, a hierarchical arrangement of data on the storage device, an amount of available storage capacity on the data device, or a back-up capability of the storage device.

In an operation 206, the received data is sent to the determined storage device. The received data may further be processed before sending the received data to the determined storage device. For example, the received data may be compressed before sending the received data to the determined storage device.

In an operation 208, a determination is made concerning whether or not the received data is sent to a reporting device. If the received data is to be sent to a reporting device, processing continues in an operation 210. If the received data is not to be sent to a reporting device, processing continues in operation 200 to continue receiving and routing the data. For example, if the computed score exceeds a second threshold, the received data may be sent to reporting device 134.

In operation 210, the data is sent to reporting device 134 and processing continues in operation 200 to continue receiving and routing the data. The data can be simultaneously sent to reporting device 134 and the determined storage device. A message may be created from the received data that is automatically routed to reporting device 134. The message may be an email message, a text message, a really simple syndication feed message, an instant message, etc. The message may be configured to trigger a display on reporting device 134.

In some cases, the storage devices are assigned a range of values. For example, a first storage device can have numerical values 0-0.25, a second storage device can have numeral values of 0.26-0.75, and a third device can have numerical values of 0.76-1.0. In some implementations, the various ranges of values may overlap and the incoming data can be sent to two (or more) of the storage devices with overlapping ranges. In some of these implementations with overlapping value ranges, the data might be simultaneously sent to multiple devices with overlapping value ranges.

Referring to FIG. 3, a block diagram of a data storage determination system 300 is shown in accordance with an illustrative embodiment. In an illustrative embodiment, data storage determination system 300 may include storage routing device 100, the plurality of storage devices 130, data source systems 132, and/or reporting device 134, and a network 302.

The components of data storage determination system 300 may be located in a single room or adjacent rooms, in a single facility, and/or may be distributed geographically from one another. Each of storage routing device 100, the plurality of storage devices 130, data source systems 132, and/or reporting device 134 may be composed of one or more discrete devices.

Network 302 may include one or more networks of the same or different types. Network 302 can be any type of wired and/or wireless public or private network including a cellular network, a local area network, a wide area network such as the Internet, etc. Network 302 further may comprise sub-networks and consist of any number of devices.

Data source systems 132 send data to storage routing device 100. Data source systems 132 can include any number and type of computing devices that may be organized into subnets. The one or more computing devices of data source systems 132 may include computers of any form factor such as a laptop 310, a desktop 308, a server computing device 306, a smart phone 304, a personal digital assistant, an integrated messaging device, a tablet computer, etc. The one or more computing devices of data source systems 132 may communicate using various transmission media that may be wired and/or wireless as understood by those skilled in the art.

Reporting device 134 receives data from storage routing device 100. Reporting device 134 can include any number and type of computing devices that may be organized into subnets. The one or more computing devices of reporting device 134 may include computers of any form factor such as a laptop 318, a desktop 316, a server computing device 314, a smart phone 312, a personal digital assistant, an integrated messaging device, a tablet computer, etc. The one or more computing devices of reporting device 134 may communicate using various transmission media that may be wired and/or wireless as understood by those skilled in the art.

Referring to FIG. 4, additional example operations associated with storage routing application 112 are described. Additional, fewer, or different operations may be performed depending on the embodiment. The order of presentation of the operations of FIG. 4 is not intended to be limiting. Although some of the operational flows are presented in sequence, the various operations may be performed in various repetitions, concurrently (in parallel, for example, using threads), and/or in other orders than those that are illustrated.

In an operation 400, a scoring algorithm is defined for one or more competitors. For example, the scoring algorithm may be defined based on a competitor evaluation and keywords associated with the competitor. The competitor evaluation may rank the competitors based on corporate sales and/or market share data. In some cases, the scoring algorithm may perform text analysis or text cluster analysis to find the value of the score.

In an operation 402, a twitter data stream is received.

In an operation 404, a competitor of the one or more competitors is determined. For example, the twitter data stream is searched for a product or competitor name to determine the competitor.

Similar to operation 202, in an operation 406, a score for the received twitter data stream is computed.

Similar to operation 204, in an operation 408, a storage device of a plurality of types of storage devices on which to store the received data is determined. In this example, the plurality of types of storage devices include a high cost storage device and a low cost storage device. The high cost storage device is determined for the storage device if the computed score is greater than 0.75, for example. Otherwise, the low cost storage device is determined. For illustration, the high cost storage device may be an electronic data warehouse, and the low cost storage device is a Hadoop® cluster.

Similar to operation 206, in an operation 410, the received twitter data stream is sent to the determined storage device.

Referring to FIG. 5, graphs presenting storage information associated with use of the data storage determination system are shown in accordance with an illustrative embodiment. In the illustrative embodiment, the graphs include a pie chart 500, a bank histogram 506, and a feed histogram 512.

Pie chart 500 includes a low cost storage percentage of use 502 and a high cost storage percentage of use 504. Low cost storage percentage of use 502 indicates that approximately 85% of the received twitter data streams are stored in the low cost storage device. High cost storage percentage of use 504 indicates that approximately 15% of the received twitter data streams are stored in the high cost storage device.

Bank histogram 506 includes a plurality of bars 508 with each bar associated with a different competitor bank. A bank “2” bar 509 and a bank “6” bar 510 indicate received twitter data streams that are stored in the high cost storage device. A remainder of the plurality of bars 508 indicates received twitter data streams that are stored in the low cost storage device. Twitter data streams associated with bank “2” and bank “6” are valued more highly than those associated with other competitor banks.

Feed histogram 512 includes a high-cost bar 514 and a low-cost bar 516. High-cost bar 514 indicates that approximately 125 thousand of the received twitter data streams are stored in the high cost storage device. Low-cost bar 516 indicates that approximately 700 thousand of the received twitter data streams are stored in the low cost storage device.

In some implementations, there could be various storage devices that are assigned values based on whether the received data is suited for immediate use and analysis (e.g., financial transaction data), daily use and analysis (e.g., daily sales figures), or future data mining (e.g., financial sales trends over a few months or years). In other implementations, a storage device may be suited for micro-batch storage, where the storage device may receive cash register transactional data that has been scored and routed to that specific type of storage device. In one example, the storage device may receive a micro-batch of data from all purchases in a transaction from a retail store or pharmacy, and may have the capability to be quickly checked for fraudulent purchases or purchases that may lead to illegal activity (e.g., illegal drugs, crystal methamphetamine, or unauthorized weapons).The terms “first,” “second,” “third,” etc., are used merely as labels, and are not intended to impose numerical requirements on their objects. The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

What is claimed is:

1. A non-transitory computer-readable medium having stored thereon computer-readable instructions that when executed by a computing device cause the computing device to:
receive data;
compute a score indicating a value associated with the received data;
determine a storage device from a plurality of types of storage devices on which to store the received data based on the computed score; and
send the received data to the determined storage device.

2. The computer-readable medium of claim 1, wherein the computer-readable instructions further cause the computing device to process the received data before sending the received data to the determined storage device.

3. The computer-readable medium of claim 1, wherein the computer-readable instructions further cause the computing device to determine a reporting device to which to send the received data based on the computed score and to send the received data to the determined reporting device.

4. The computer-readable medium of claim 3, wherein the computer-readable instructions further cause the computing device to create a message from the received data, wherein the message is sent to the reporting device.

5. The computer-readable medium of claim 4, wherein the message is selected from the group consisting of an email message, a text message, a really simple syndication feed message, and an instant message.

6. The computer-readable medium of claim 4, wherein the message is configured to trigger a display on the reporting device.

7. The computer-readable medium of claim 1, wherein the determination is based on a comparison between the score and a threshold associated with each of the plurality of types of storage devices.

8. The computer-readable medium of claim 7, wherein the determination is further based on a default storage device assignment unless the comparison indicates a different type of storage device of the plurality of types of storage devices.

9. The computer-readable medium of claim 7, wherein the threshold is defined based on a cost associated with use of the associated type of storage device.

10. The computer-readable medium of claim 7, wherein the threshold is defined based on an access time associated with use of the associated type of storage device.

11. The computer-readable medium of claim 7, wherein the threshold is defined based on an ease of access value associated with use of the associated type of storage device.

12. The computer-readable medium of claim 7, wherein the threshold associated with each type of storage device of the plurality of types of storage devices increases monotonically and the computed score is less than the threshold for the determined storage device.

13. The computer-readable medium of claim 7, wherein the threshold associated with each type of storage device of the plurality of types of storage devices decreases monotonically and the computed score is greater than the threshold for the determined storage device.

14. The computer-readable medium of claim 1, wherein the data is received in a data stream.

15. The computer-readable medium of claim 14, wherein the score is computed on the received data in the data stream.

16. The computer-readable medium of claim 1, wherein the data is received from a plurality of data sources.

17. A computing device comprising:
a processor; and
a non-transitory computer-readable medium operably coupled to the processor, the computer-readable medium having computer-readable instructions stored thereon that, when executed by the processor, cause the computing device to
receive data;
compute a score indicating a value associated with the received data;
determine a storage device from a plurality of types of storage devices on which to store the received data based on the computed score; and
send the received data to the determined storage device.

18. The computing device of claim 17, wherein the data is received in a data stream.

19. The computing device of claim 18, wherein the score is computed on the received data in the data stream.

20. The computing device of claim 17, wherein the determination is based on a comparison between the score and a threshold associated with each of the plurality of types of storage devices.

21. The computing device of claim 20, wherein the threshold is defined based on a cost associated with use of the associated type of storage device.

22. A system comprising:
a plurality of storage devices; and
a computing device comprising
a processor; and
a computer-readable medium operably coupled to the processor, the computer-readable medium having computer-readable instructions stored thereon that, when executed by the processor, cause the computing device to:
receive data;
compute a score indicating a value associated with the received data;
determine a storage device from the plurality of types of storage devices on which to store the received data based on the computed score; and
send the received data to the determined storage device.

23. The system of claim 22, wherein the data is received in a data stream.

24. The system of claim 23, wherein the score is computed on the received data in the data stream.

25. The system of claim 22, wherein the determination is based on a comparison between the score and a threshold associated with each of the plurality of types of storage devices.

26. The system of claim 25, wherein the threshold is defined based on a cost associated with use of the associated type of storage device.

27. A method of determining a storage device on which to store received data, the method comprising:
receiving data;
computing, by a computing device, a score indicating a value associated with the received data;
determining, by the computing device, a storage device from a plurality of types of storage devices on which to store the received data based on the computed score; and
sending the received data to the determined storage device.

28. The method of claim 27, wherein the data is received in a data stream.

29. The method of claim 28, wherein the score is computed on the received data in the data stream.

30. The method of claim 27, wherein the determination is based on a comparison between the score and a threshold associated with each of the plurality of types of storage devices.

31. The method of claim 30, wherein the threshold is defined based on a cost associated with use of the associated type of storage device.
